(19) United States
(12) Patent Application Publication
(10) Pub. No.: US 2007/0121657 A1
(43) Pub. Date: May 31, 2007

(54) Method and communication device for providing a personalized ring-back

(76) Inventors: Marc A. Boillot, Plantation, FL (US); Pratik V. Desai, Boca Raton, FL (US); Radu C. Frangopol, Plantation, FL (US); Chin P. Wong, Parkland, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/290,048

(22) Filed: Nov. 30, 2005

(51) Int. Cl. H04L 12/28

(52) U.S. Cl. 370/403; 379/82; 379/179; 379/207.16

(57) ABSTRACT

The invention concerns a communication device (102) and a method (200) for providing a personalized ring-back to a first user of the first communication device (102), when the first user initiates a phone call with a second user of a second communication device (104). In one arrangement, the method can include the steps of detecting (204) reception of a ring-back signal at the first communication device (102) received from a communication network (108), retrieving (206) a multimedia file in the first communication device (102), and playing (208) the multimedia file in the first communication device (102) for at least the duration of the ring-back signal.

### BACKGROUND OF THE INVENTION

1. Field of the Invention

This invention relates in general to communication devices and more particularly, to a system and method for providing a personalized ring-back to communication devices.

2. Description of the Related Art

During the last few decades, there has been a significant growth in the usage of communication devices, such as mobile phones. Continuous efforts are being made to provide a whole range of new features that improve the user's experience of these communication devices.

A customized ring-back tone service is an example of one such feature that improves the user's experience while making a phone call. A subscriber of the customized ring-back tone service can select an audio clip, from amongst various audio clips that are provided by a communication network, as a ring-back tone. That is, the subscriber can select a ring-back tone from the network that a person calling the subscriber will hear when that person calls the subscriber. Thereafter, the caller can listen to the audio clip, such as a song, while waiting for the phone call to be established with the subscriber.

In this type of system, however, significant modifications are required in the communication network, as additional hardware/software modules may be necessary to provide these services. Further, in the existing systems, the subscriber decides which audio clip a caller will listen to as a ring-back tone, as the caller has no control over this procedure. Moreover, the quality of the audio files that are transmitted to the calling party's wireless unit is limited by bandwidth constraints. This quality issue even applies to landline telephones.

### SUMMARY OF THE INVENTION

The present invention concerns a method of providing a personalized ring-back to a first user of a first communication device when the first user of the first communication device initiates a phone call with a second user of a second communication device. The method can include the steps of detecting reception of a ring-back signal at the first communication device from a communication network, retrieving a multimedia file stored in the first communication device, and playing the multimedia file for at least a portion of the duration of the ring-back signal. In one arrangement, the first communication device can receive the ring-back signal from a switching center in the communication network. The method can also include the step of identifying a standard ring-back signal or a customized ring-back signal set by the second user.

Retrieving the multimedia file can include the step of identifying the multimedia file selected by the first user for playing as the personalized ring-back, as the multimedia file can be stored in a memory unit of the first communication device. Playing the multimedia file can include the step of rendering the multimedia file to a multimedia player in the first communication device for processing the multimedia file. In one arrangement, the multimedia file can be paused until a next ring-back signal is received from the communication network. Further, on reception of the next ring-back signal, the multimedia file can be played from the point where the multimedia file was paused.

The method can further include the step of stopping the multimedia file when the second user either answers the phone call or disconnects it. In one particular embodiment, the method can include the step of downloading a multimedia file from a network, for example, the Internet, to the memory unit of the first communication device. Further, a multimedia file can also be transferred from an electronic device—such as a computer, a mobile phone, a personal digital assistant, a compact disk or an audio player—to the memory unit of the first communication device. The method can further include the step of providing an option to the first user to select a standard ring-back tone, a second user customized ring-back, or the personalized ring-back, to be played as a ring-back, until the second user answers the phone call or disconnects it, for example.

The present invention also concerns a communication device. The communication device can include a memory unit capable of storing at least one multimedia file, a multimedia player that can play the multimedia file and can be operatively coupled to the memory unit, and a processor, which can be operatively coupled to the memory unit and the multimedia player. The processor can be programmed to identify a ring-back signal transmitted from a communication network, retrieve the multimedia file from the memory unit, and render the multimedia file to the multimedia player for playing the multimedia file as a ring-back, at least for a portion of the duration of the ring-back signal.

In addition, the communication device can include at least one speaker, at least one display or at least one haptics mechanism for providing a multimedia output. In one particular embodiment, the communication device can include a network access module for downloading a multimedia file from a network, for example, the Internet, to the memory unit. The communication device can also include a data input-output module for transferring a multimedia file from an electronic device, for example, a computer, to the memory unit. In one arrangement, the first communication device can include an identification module operatively coupled to the processor, which is capable of identifying whether the ring-back signal is a multimedia file. As an example, the multimedia file can be an audio file that is a Motion Picture Experts Group (MPEG) layer 3 (MP3) file, an Advanced Audio Coding (AAC) file, an Advanced Audio Coding plus (AAC+) file, a Window Media Audio (WMA) file, a Waveform Audio (WAV) file, a Musical Instrument Digital Interface (MIDI) file, or an Ogg vorbis file.

The present invention also concerns a computer program product for use with a computer. The computer program product can include a computer usable medium having a computer readable program code embodied therein for providing a personalized ring-back to a user of a first communication device. The user of the first communication device can initiate a phone call with a user of a second communication device. The computer readable program code can cause the first communication device to detect reception of a ring-back signal at the first communication device from a communication network, retrieve a multimedia file in the first communication device and play the multimedia file in the first communication device for at least a portion of the duration of the ring-back signal. The program code can also cause the first communication device to perform any of the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an example of a communication system, in accordance with various embodiments of the inventive arrangements;

FIG. 2 illustrates an example of a method for providing a personalized ring-back, in accordance with an embodiment of the inventive arrangements; and

FIG. 3 illustrates an example of a block diagram of a first communication device, in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality” as used herein, is defined as two or more than two. The term “another” as used herein, is defined as at least a second or more. The terms “including” and/or “having” as used herein, are defined as comprising (i.e., open language). The term “coupled” or “operatively coupled” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The invention concerns a communication device and a method for providing a personalized ring-back. In one arrangement, the method can include the steps of detecting reception of a ring-back signal at a first communication device from a communication network, retrieving a multimedia file in the first communication device, and playing the multimedia file in the first communication device, when a first user of the first communication device initiates a phone call with a second user of a second communication device. This process can enable a caller to enjoy multimedia files at his or her convenience when making a call and because the multimedia files may be stored in the caller's wireless unit, the quality of the multimedia files can be increased, as compared to receiving the files from a network.

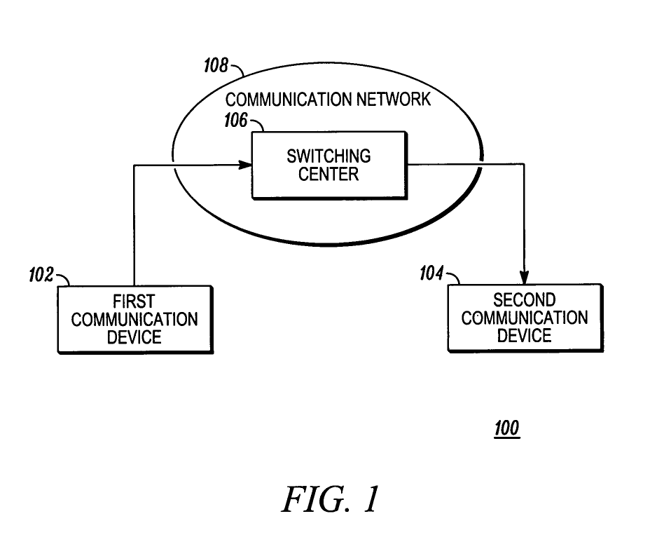

Referring to FIG. 1, an example of a communication system 100 is shown. In one embodiment, the communication system 100 can include a first communication device 102 and a second communication device 104. The communication system 100 can further include a switching center 106. As an example, one or both of the first communication device 102 and the second communication device 104, can be wireless communication devices, such as mobile phones, and can communicate with each other through a communication network 108. Of course, one or both of the first communication device 102 and the second communication device 104 can be wired communication devices, such as landline phones that can communicate with one another through the communication network 108. As such, the communication network 108, as those of skill in the art will appreciate, can be configured to support both wired and wireless communications. The communication network 108 can be configured to transmit and receive any suitable type of communications signals, including voice and data signals.

In one arrangement, a first user of the first communication device 102 may initiate a phone call with a second user of the second communication device 104. As is known in the art, the switching center 106 of the communication network 108 can connect the first communication device 102 with the second communication device 104. As is also known in the art, the switching center 106 can transmit a ring-back signal to the first communication device 102 to indicate that a connection with the second communication device 104 is being established. In an embodiment, the ring-back signal transmitted from the switching center 106 can be a standard ring-back signal or a ring-back signal that is customized or set by the second user. The first user can listen to, for example, the ring-back signal while the first user waits for the second user to answer the phone call. The ring-back signal can be transmitted from the switching center 106 until the second user answers the phone call or disconnects it.

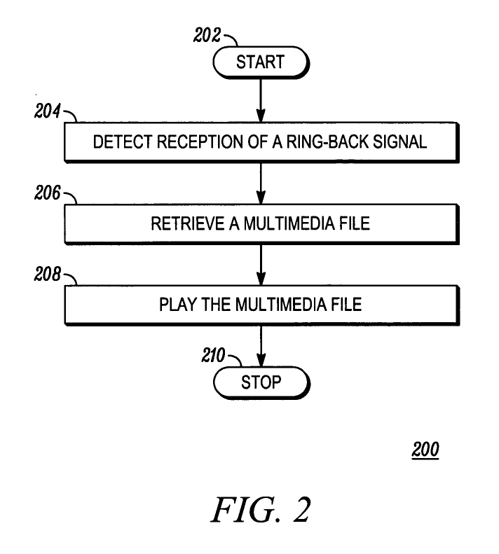

Referring to FIG. 2, a method 200 for providing a personalized ring-back is shown. To describe the method 200, reference will be made to FIG. 1, although it is understood that the method 200 can be implemented in any other suitable device or system. Moreover, the invention is not limited to the order in which the steps are listed in the method 200. In addition, the method 200 can contain a greater or fewer numbers of steps than those shown in FIG. 2.

In one arrangement, the method 200 can include one or more method steps for providing a personalized ring-back to a first user of the first communication device 102, when the first user initiates a phone call with a second user of the second communication device 104. A ring-back can be any sensory-perceptible event that can be experienced by a caller when the caller initiates a call and is waiting for the called party to respond. At step 202, the method 200 can start. At step 204, the first communication device 102 can detect whether a ring-back signal has been received from the communication network 108. In an embodiment, the first communication device 102 can receive the ring-back signal from the switching center 106 in the communication network 108. In another embodiment, the ring-back signal can be identified as, for example, a standard ring-back signal or a customized ring-back signal set by the second user.

Once the ring-back signal is detected at step 204, step 206 can be performed. At step 206, a multimedia file can be retrieved in the first communication device 102. The term multimedia file can include any data that may cause the communication device 102 to play any suitable type of audio and/or video and/or to perform a haptics event, such as an action that can be felt by a user. In an embodiment, the multimedia file can be retrieved from a memory unit in the first communication device 102. The multimedia file can be selected by the first user to be played as the personalized ring-back.

At step 208, the multimedia file can be played in the first communication device 102 for at least a portion of the duration of the ring-back signal. As a result, the first user can select to play the multimedia file as the ring-back instead of listening to the standard ring-back tone or the second user customized ring-back tone. This enables the first user to override the ring-back set by the network or the second user. In an embodiment, the multimedia file can be played by rendering the multimedia file to an audio player in the first communication device 102. The multimedia file can be, for example, made available to a multimedia player for processing. The multimedia player can be any device that is capable of performing any action that corresponds to the data of the multimedia file. In another embodiment, the multimedia file can be paused until the reception of a next ring-back signal from the communication network 108. In this embodiment, the multimedia file can be played again, from the position where it was paused, for example, if the next ring-back signal is received from the communication network 108.

Further, the multimedia file can be stopped in case no ring-back signal is received by the first communication device 102 from the communication network 108. For example, the multimedia file being played can be stopped when the second user answers the phone call. As another example, the multimedia file being played can be stopped if the second user disconnects the phone call.

In one arrangement, a multimedia file can be downloaded to a memory unit of the first communication device 102 from a network, for example, the Internet. In another embodiment, a multimedia file can be transferred to the memory unit from another electronic device, such as a computer, a mobile phone, a laptop, a Personal Digital Assistant (PDA), a Compact Disk (CD) player, or an audio player. Further, the first user can be provided an option to select a standard ring-back tone, a second user customized ring-back, or the personalized ring-back, to be played as a ring-back, until the second user answers the phone call or disconnects it.

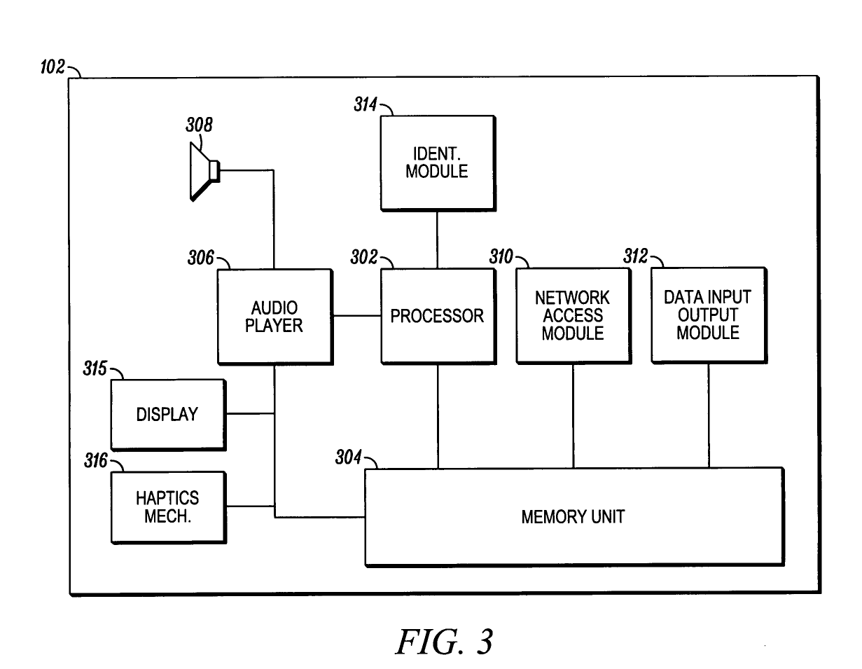

Referring to FIG. 3, an example of a block diagram of a first communication device 102 is shown. Those of skill in the art will appreciate that the first communication device 102 may include all or even a fewer number than the components shown in FIG. 3. Also, those of skill in the art will understand that the first communication device 102 may include additional components that are not shown here but are not germane to the operation of the first communication device 102, in accordance with the inventive arrangements.

Here, the first communication device 102 can include a processor 302, a memory unit 304, and a multimedia player 306. The first communication device 102 may also include at least one speaker 308, a network access module 310, a data input-output module 312, and an identification module 314. The multimedia player 306 can be operatively coupled to the memory unit 304 and the speaker 308. The processor 302 can be operatively coupled to the memory unit 304 and the multimedia player 306. The communication device 102 may also include a display 315 and/or a haptics mechanism 316, such as a vibrator, which may also be operatively coupled to the memory unit 304.

In one arrangement, the memory unit 304 can be capable of storing, for example, at least one multimedia file. As an example, the multimedia file may be an audio file that can be used as a ring-back. Examples of the audio file include, but are not limited to, a Motion Picture Experts Group (MPEG) layer 3 (MP3) file, an Advanced Audio Coding (AAC) file, an Advanced Audio Coding plus (AAC+) file, a Window Media Audio (WMA) file, a Waveform Audio (WAV) file, a Musical Instrument Digital Interface (MIDI) file, and an Ogg vorbis file. Further, the multimedia player 306 is capable of playing the audio file using the speaker 308.

As another example, the multimedia file may be a video file, which can include moving and still images. Examples of suitable video files include MPEG-2, MPEG-4 and JPEG. The multimedia player 306 can play the video file using the display 315. The multimedia file may also include data for creating a haptics experience. As an example, the multimedia player 306 can play the multimedia file by generating vibrations on the communication device 102 through the haptics mechanism 316. The multimedia file may include any combination of audio, video and haptics data. Based on the multimedia file, the multimedia player 306 can activate either one of the speaker 308, the display 315 or the haptics mechanism 316. In other words, these devices can be activated in any suitable combination, including individually, and at any suitable time. Also, the invention is not limited to these particular examples, as the multimedia player 306 can be used to activate any other suitable component that can provide a sensory-perceptible experience to a user of the communication device 102.

The processor 302, for example, can provide processing capabilities for the various functions of the first communication device 102. As an example, the processor 302 can identify a ring-back signal transmitted from the switching center 106 in the communication network 108. In particular, the identification module 314 can identify the ring-back signal and can signal the processor 302 with such information. As an example, the identification module 314 can identify standard ring-back signals. Additionally, the ring-back signal may be a music file that was set (or customized) by the second user of the second communication device 104. In this case, the identification module 314 can be a vocoder that is capable of recognizing music frames. Examples of the vocoder 314 can include, but are not limited to, a Vector Sum Excited Linear Predictive (VSLEP) vocoder, a Multi-Band Excitation (MBE) vocoder, and an Adaptive Multi-Rate (AMR) vocoder. Of course, the identification module 314, as is known in the art, can be configured to recognize video frames, too. Based on this identification, the processor 302 can be signaled to override the standard ring-back tone or the customized ring-back set by the second user with the personalized ring-back set by the first user and can retrieve a multimedia file from the memory unit 304. Further, the processor 302 can render the multimedia file to the multimedia player 306 for playing it as a personalized ring-back.

In one arrangement, the first communication device 102 can use the network access module 310 to download a multimedia file to the memory unit 304, from a network, such as the Internet. In another embodiment, the first communication device 102 can use the data input-output module 312, to transfer a multimedia file from an electronic device to the memory unit 304. Examples of the data input-output module include, but are not limited to, an infrared port, a USB port, and a Bluetooth port. Examples of the electronic device include, but are not limited to, a computer, a mobile phone, a laptop, a Personal Digital Assistant (PDA), a Compact Disk (CD) player, or an audio player. As such, the user of the communication device 102 can create any suitable type of multimedia file to be played while the user is initiating a call on the device 102.

Various embodiments of the inventive arrangements have the advantage of providing an option to the caller to select his/her favorite multimedia file for playing as the ring-back. Further, since the multimedia file being played as the ring-back is stored locally in the caller's communication device, better audio quality of the ring-back can be achieved as compared to conventional customized ring-back systems. Moreover, there is no requirement of making changes in the communication network for the working of the present invention. In addition, the billing and service of the personalized ring-back can be controlled by the caller, instead of the communication network.

Where applicable, the present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method of providing a personalized ring-back to a first user of a first communication device, the first user of the first communication device initiating a phone call with a second user of a second communication device, the method comprising:
detecting reception of a ring-back signal at the first communication device from a communication network;
retrieving a multimedia file in the first communication device; and
playing the multimedia file in first communication device for at least a portion of the duration of the ring-back signal.

2. The method according to claim 1, wherein the first communication device receives the ring-back signal from a switching center in the communication network.

3. The method according to claim 1, wherein detecting reception of the ring-back signal comprises identifying a standard ring-back signal or a customized ring-back signal set by the second user.

4. The method according to claim 1, wherein retrieving the multimedia file comprises identifying the multimedia file stored in a memory unit of the first communication device, the multimedia file being selected by the first user for playing as the personalized ring-back.

5. The method according to claim 1, wherein playing the multimedia file comprises rendering the multimedia file to a multimedia player in the first communication device.

6. The method according to claim 5, wherein rendering the multimedia file comprises making the multimedia file available to the multimedia player for processing.

7. The method according to claim 1, further comprising pausing the multimedia file until reception of a next ring-back signal from the communication network.

8. The method according to claim 7, further comprising playing the multimedia file from the position where the multimedia file was paused when the next ring-back signal is received from the communication network.

9. The method according to claim 1, further comprising stopping the multimedia file when the second user answers the phone call.

10. The method according to claim 1, further comprising stopping the multimedia file when the second user disconnects the phone call.

11. The method according to claim 1, further comprising downloading a multimedia file from a network to a memory unit of the first communication device.

12. The method according to claim 1, further comprising transferring a multimedia file from an electronic device to a memory unit of the first communication device.

13. The method according to claim 12, wherein the electronic device is a computer, a mobile phone, a laptop, a Personal Digital Assistant (PDA), a Compact Disk (CD) player, or an audio player.

14. The method according to claim 1, further comprising providing an option to the first user to select a standard ring-back tone, a second user customized ring-back, or the personalized ring-back.

15. A communication device, comprising:
a memory unit capable of storing at least one multimedia file;
a multimedia player operatively coupled to the memory unit, wherein the multimedia player plays the multimedia file; and
a processor operatively coupled to the memory unit and the multimedia player, wherein the processor is capable of:
identifying a ring-back signal transmitted from a communication network switching center;
retrieving the multimedia file from the memory unit; and
rendering the multimedia file to the multimedia player, wherein the multimedia file is played as a ring-back for at least a portion of the duration of the ring-back signal.

16. The communication device according to claim 15, wherein the communication device comprises at least one speaker, at least one display or at least one haptics mechanism for providing a multimedia output.

17. The communication device according to claim 15, further comprising a network access module for downloading a multimedia file from a network to the memory unit.

18. The communication device according to claim 15, further comprising a data input-output module for transferring a multimedia file from an electronic device to the memory unit.

19. The communication device according to claim 15, further comprising an identification module operatively coupled to the processor, wherein the identification module is capable of identifying whether the ring-back signal is a multimedia file.

20. The communication device according to claim 15, wherein the multimedia file is an audio file that is a Motion Picture Experts Group (MPEG) layer 3 (MP3) file, an Advanced Audio Coding (AAC) file, an Advanced Audio Coding plus (AAC+) file, a Window Media Audio (WMA) file, a Waveform Audio (WAV) file, a Musical Instrument Digital Interface (MIDI) file, or an Ogg vorbis file.

21. A computer program product for use with a computer, the computer program product comprising a computer usable medium having a computer readable program code embodied therein for providing a personalized ring-back to a user of a first communication device, the user of the first communication device initiating a phone call with a user of a second communication device, the computer readable program code causing the first communication device to:
detect reception of a ring-back signal at the first communication device from a communication network;
retrieve a multimedia file in the first communication device; and
play the multimedia file in the first communication device for at least a portion of the duration of the ring-back signal.
